(19) United States
(12) Patent Application Publication
(10) Pub. No.: US 2006/0070532 A1
(43) Pub. Date: Apr. 6, 2006

(54) Desk-top steaming apparatus

(76) Inventor: Rong-Kuan Chang, Taipei (TW)

Correspondence Address: Chang Rong-Kuan, P.O.Box 166-13, Taipei, 115, TW

(21) Appl. No.: 10/958,874

(22) Filed: Oct. 6, 2004

(51) Int. Cl. A23B 4/044

(52) U.S. Cl. 99/476

(57) ABSTRACT

The desk-top steaming apparatus comprises both the body and base, and water tank and water boilers are equipped inside the base. A water intake pipe and an exhaust pipe connect both the tank and boiler, and the position of the exhaust pipe is higher than that of the water intake pipe. This type of base helps fast boiling and produces vapor, and it also has automatic water supply. Next, a light base and an advertising lampshade may be equipped on the top of the body, and the light from light base can be projected into the body to show food clearly in order to catalyze advertising effect.

### FIELD OF THE INVENTION

The present invention relates to steaming apparatus; and particularly to a desk-top steaming apparatus that can be fast boiling and produces vapor, and it has automatic water supply.

### BACKGROUND OF THE INVENTION

Today's steaming apparatuses are used for steamed food products like steamed stuffed bun, steamed dumplings, rice cakes etc., and most of the apparatuses are large-scaled objects. The one I previously applied and approved by U.S. patent Ser. No. 09/240,662 of “Structure of a steaming apparatus” is an example. However, large-scaled steaming apparatus is bulky; it is suitable only for professional steamed food manufacturers and has to be put on the floor. For stores with limited area and space such as bistros, convenient stores, fast food or breakfast restaurants, Japanese pub houses, specialty cuisine restaurants, etc., it is impossible to use large-scaled steaming apparatuses since there is no enough space for it. If there is small-scaled steaming apparatus, which can be put on the desk-top, previous problems can be solved. In the light of the situation, some advancers have developed small-scaled steaming apparatuses. However, there are still some drawbacks shown as follows:
1. Most of the old-styled small steaming apparatuses are operated by adding water with human labor, therefore, users need to constantly pay attention to the machine in case it need more water supply. This is very inconvenient to the users.
2. The lesser the water is in the steaming apparatus, the faster it becomes for evaporation. The water level for old-styled steaming apparatus is not controllable. Too much water will cause longer boiling time and thus waste both time and energy.
3. The top of the front edge of the steaming rack is easily accumulated by water. Water drips while the racks are pulled out and thus damp both the desk-top and floor.
4. If food is put at the front side of the racks, the center of gravity is located at the front; when racks are pulled out, they may easily tilted and slipped down.
5. The top of the steaming apparatus has no advertising devices, so it is hard to attract the attention of the passers-by and diners in the dark.

### SUMMARY OF THE INVENTION

A desk-top steaming apparatus typically comprises the body and base. The body has a plurality of stacks of drawer-typed steaming racks. The bottom two sides of each rack are supported by slide tracks, so that the racks can slide easily on the tracks and can be pulled out from the front side of the body. The base has a water tank and a water boiler, which are connected by a water intake pipe and an exhaust pipe. The position of the exhaust pipe is higher than that of the water intake pipe. In addition, there is a high-pressure exhaust vent on the central top of the water boiler. On the top of the vent, a knob is set to hamper high-pressure exhaust vapor and lead it to disperse radiantly. Next, a light base and an advertising lampshade can be added on the top of the body. Inside the water tank, a circuit breaker is equipped to prevent electric current overloads when there is no water supply. Also, the light from the light base can be projected directly into the body of the steaming apparatus so that all food can be presented clearly and can also catalyze the advertising effects.

### BRIEF DESCRIPTION OF THE DRAWINGS

FIG. 1: The pictorial drawing of the small-scaled steaming apparatus.

FIG. 2: The constructional drawing of the steaming rack and slide track.

FIG. 3: Cross section of 3-3 of FIG. 2.

FIG. 4: The schematic drawing of the operation of the steaming rack and slide track.

FIG. 5: Cross section of the water tank.

FIG. 6: Cross section of the water tank.

FIG. 7: The constructional drawing of the connection between the water tank and water boiler.

FIG. 8: The schematic drawing of water supply for the water tank and water boiler.

FIG. 9: The pictorial drawing of the apparatus from another angle.

FIG. 10: Cross section of 10-10 of FIG. 7.

FIG. 11: The pictorial drawing of the light base and lampshade.

FIG. 12: The constructional drawing of the light base and lampshade.

FIG. 13: Another type of the pictorial drawing of the steaming apparatus.

FIG. 14: The assembly drawing of the water tank and water boiler in FIG. 13.

FIG. 15: The exploded view of the water tank and water boiler in FIG. 14.

### DETAILED DESCRIPTION

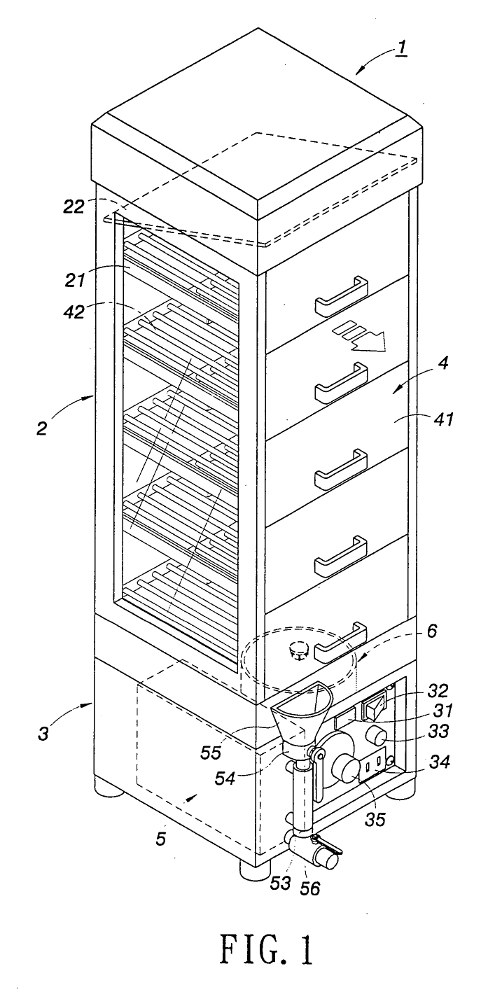

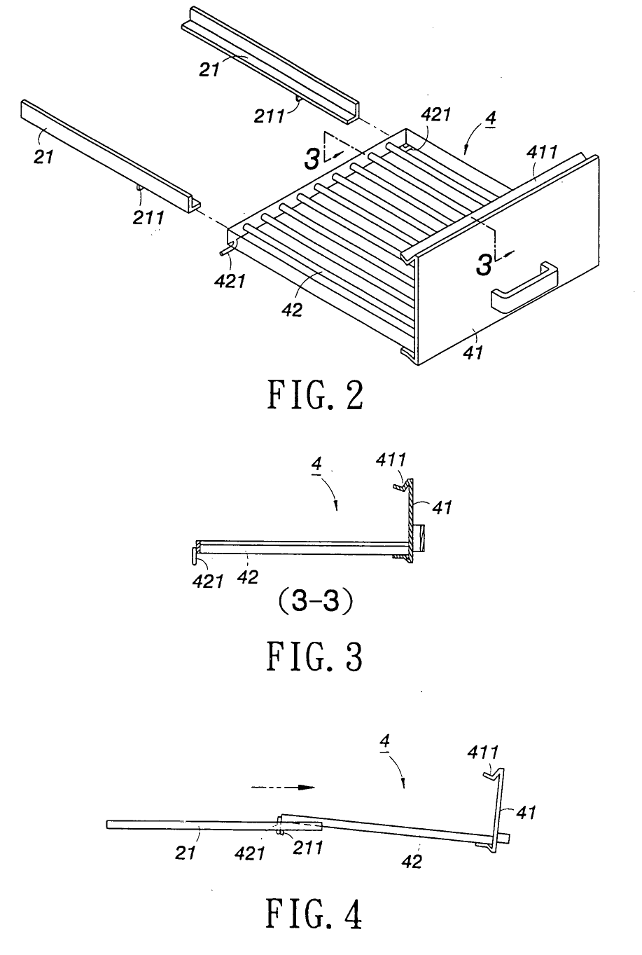

FIG. 1 shows the pictorial drawing of the desk-top steaming apparatus. The drawing shows the small-scaled steaming apparatus (1) comprises the body (2) and the base (3). The body (2) can be equipped with a plurality of L-shaped stack of drawer-typed steaming racks (4), the two sides of each rack (4) are all supported by slide tracks (21). <See FIG. 2> The water level indicator light (31), on/off switch (32), fuse (33), outlet (34) for the fluorescent lamp and thermostat (35) may be installed on the lower part of the front of the base (3).

The structure of the steaming rack (4) is shown on FIG. 2, which comprises a front panel (41) and a support rack (42) with several parallel poles. The top edge of the front panel (41) has a water guiding slot (411), which leads the evaporated water to flow through both sides then into the body (2) and thus prevents water from dripping on the desk top or floor when the steaming racks (4) are pulled out. The rear bottom of the support rack (42) has rack hooks (421) on two sides. <See FIG. 3> When steaming racks (4) are pulled out from the body (2), the buffers (211) attached on the bottom of the slide tracks (21) of the body (2) can stop the rack hooks (421) <See FIG. 2 & FIG. 4> in order that the steaming racks (4) will not be pulled further. In this way, they can prevent from the loss of the center of gravity.

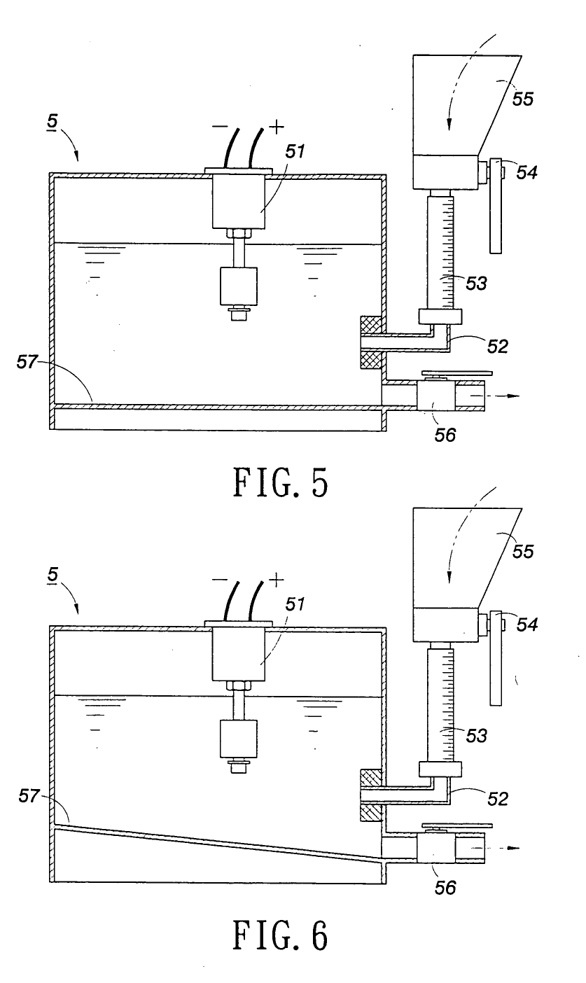

FIG. 1 also shows a water tank (5) and a water boiler (6) <could be round or square shape> inside the base (3). Water tank (5) is equipped with a circuit breaker (51) <See FIG. 5>, it can break the electric power to prevent the overload of electric current when there is no water supply. In addition, the water tank (5) connects with a water intake pipe (52), a transparent duct (53), a water intake valve (54) <optional> and a funnel (55). When the water intake valve is on, water can be poured from the funnel (55) then through the transparent duct (53), the water intake pipe (52) and finally to the water tank (5). We can tell whether the water level is full by looking at the transparent duct (53). A drain pipe also connects to the water tank (5), this pipe is equipped with a drain valve (56). After a long period of time, the precipitation at the bottom of the tank can be drained by turning on the drain valve (56). Also, the bottom panel (57) of the water tank can be either level or tilted, if it comes with tilted panel, <See FIG. 6> water can be easily drained.

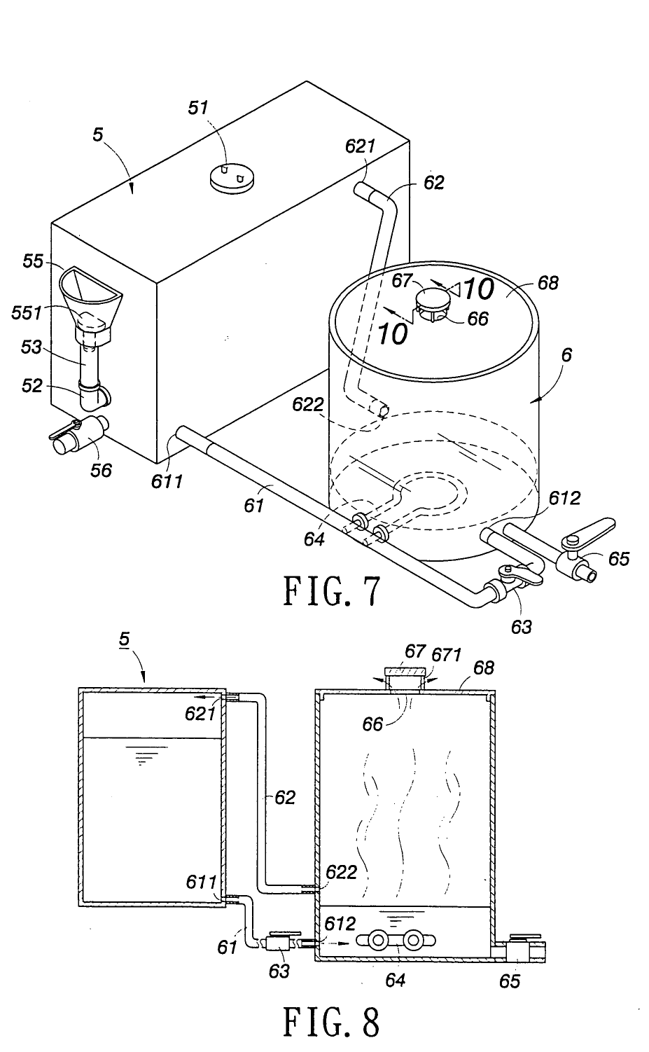

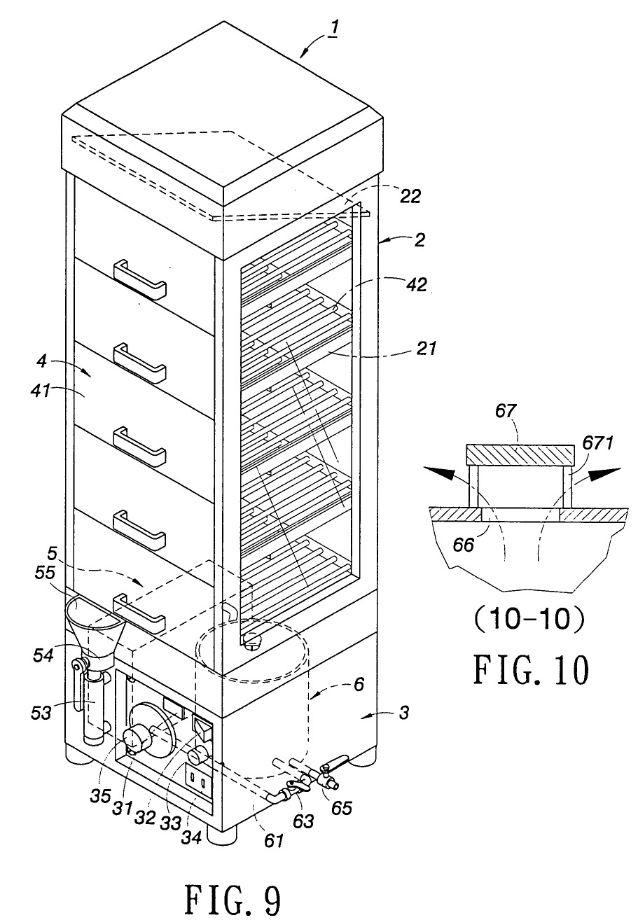

FIG. 7 is the constructional drawing of water tank and water boiler. The figure shows that the water intake pipe (61) and exhaust pipe (62) connect between water tank (5) and water boiler (6). It will be appropriate position if the bottom of the water tank (5) is higher than that of the water intake pipe (61). Both ends (611&612) of water intake pipe (61) connect to the lower position of both water tank (5) and water boiler (6) respectively, while the two ends (621&622) of the exhaust pipe (62) connect to the higher position of the water tank (5) and the lower position of the water boiler (6), respectively. The position of the exhaust vent (622) has to be higher than that of the water intake hole (612). A water intake valve (63) is positioned appropriately somewhere on the top of water intake pipe (61). Also a heating unit (64) <e.g. gas stove or electric heat coil> and a drain valve (65) are located on the lower level of the water boiler (6). Both water intake valve (63) and drain valve (65) are exposed outside of the base (3). <See FIG. 9> When there is not enough water supply in the water boiler (6), water will be supplied from the tank (5) automatically through the water intake pipe (61) then finally to the boiler (6). When water level reaches the position of the exhaust pipe (62) and fully covers the exhaust vent, air will not be able to get into the water tank (5). Since the tank (5) becomes a vacuum object, there is no way to supply water from tank (5) to boiler (6). Moreover, the position of the exhaust vent (622) inside the boiler (6) is not high, there will not be too much water intake. Therefore, it can rapidly produce high heat vapor after short period of time, also, it helps time saving and energy conservation. When water level below the exhaust vent (622), water tank (5) will supply water automatically till the exhaust vent (622) fully covered. In the light of automatic water supply, there is no scarcity of water supply for boiler (6).

In front of the water tank (5), there is no water intake valve on the top of the transparent duct (53). Therefore, a valve (551) may be added at the entrance of the funnel (55). After the tank (5) reaches full level, valve (551) may close the entrance of the funnel in order to make the tank (5) a vacuum object. If there is a water intake valve (54) positioned at the bottom of the funnel, the valve (54) can be closed when the tank is full.

The lid (68) of the boiler (6) can be either movable or fixed. In order to disperse high heat vapor, there may have several vent holes (not shown in drawings) or a central vent (66) on the top of the lid (68) on the top of the lid (68) <as shown on FIG. 10>. A knob (67) is located on the top of the vent supported by several poles (671). When high heat evaporates from the central vent (66), it will be hampered by the knob (67) and disperse radiantly.

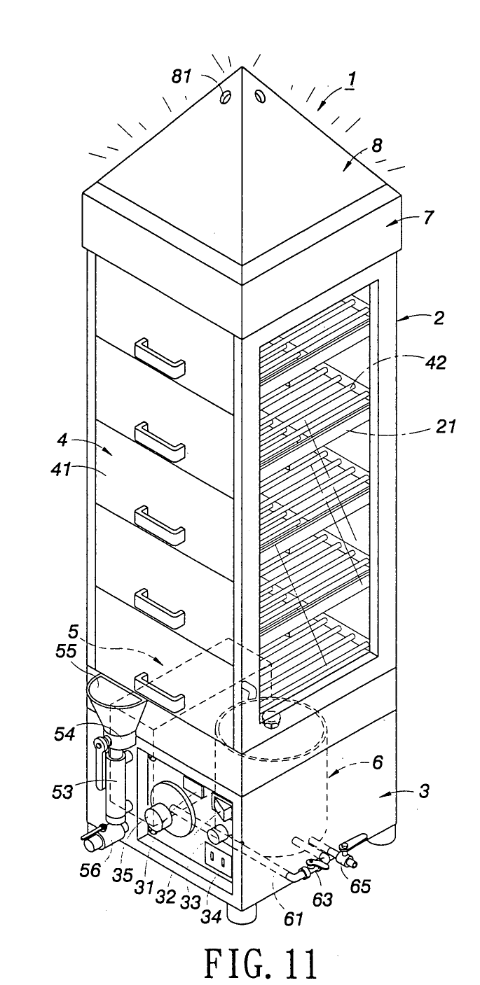

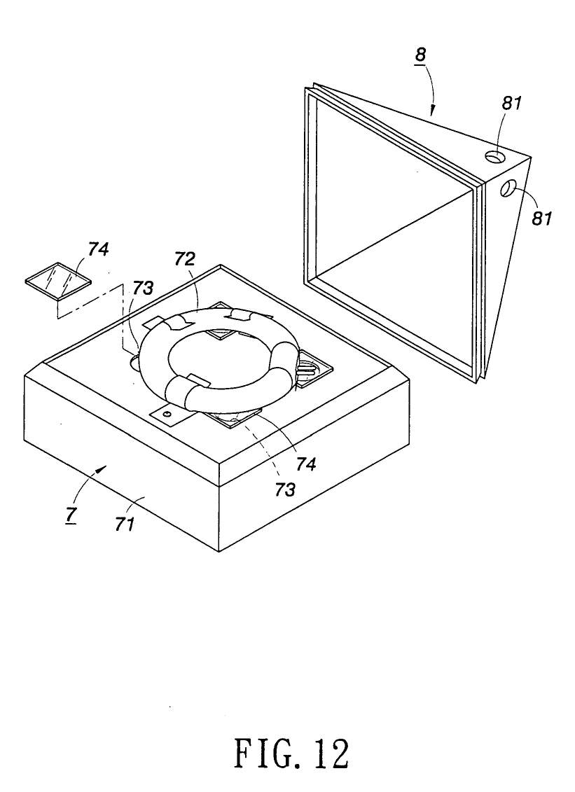

FIG. 11 shows a tilted water guiding glass plate (22) inside the upper position of the body (2). This will help liquid flow down after vapor condensing to water and prevent from dripping to the food so that the food still keeps its original flavor. Besides, a light base (7) and a lampshade (8) can be added on the top of the body (2), the construction of both is presented on FIG. 12. Light base (7) has a lamp body (71) topped with a lamp pipe (72). In order to project the light from lamp pipe (72) into the steaming apparatus body (2), several holes (73) can be designed on the top of lamp body (71) and covered with transparent lens (e.g. transparent plastic lens, acrylic lens, or glass lens), light thus can project through the lens (74), the tilted water guiding glass plate (22), then finally into the steaming apparatus body (2). Therefore, it can clearly show to the side walkers or diners the food during the dark. Besides, the lamp shade (8) on the top of lamp base (7) can be designed as either triangle or cone shapes, if any. Several vent holes (81) on the top of the lampshade (8) will help release the heat.

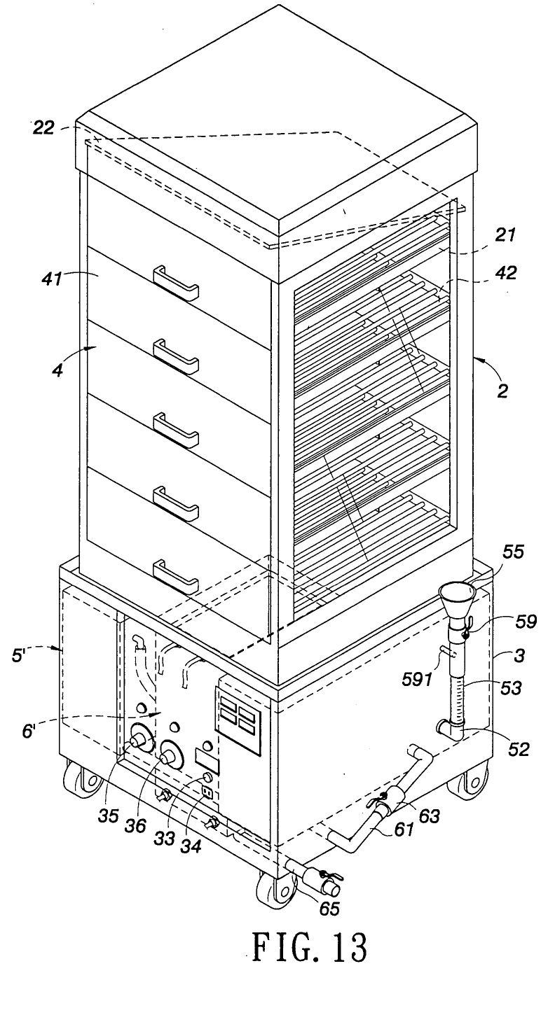

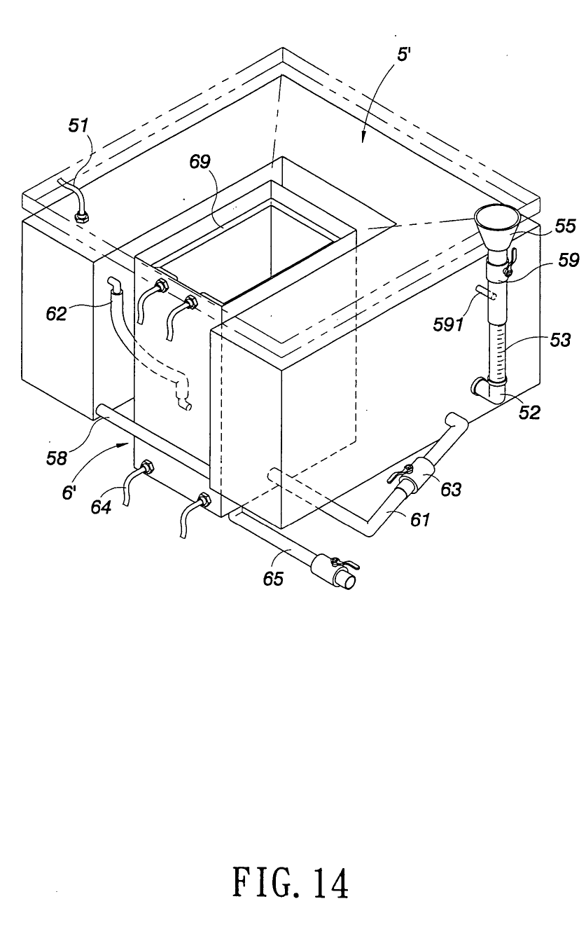

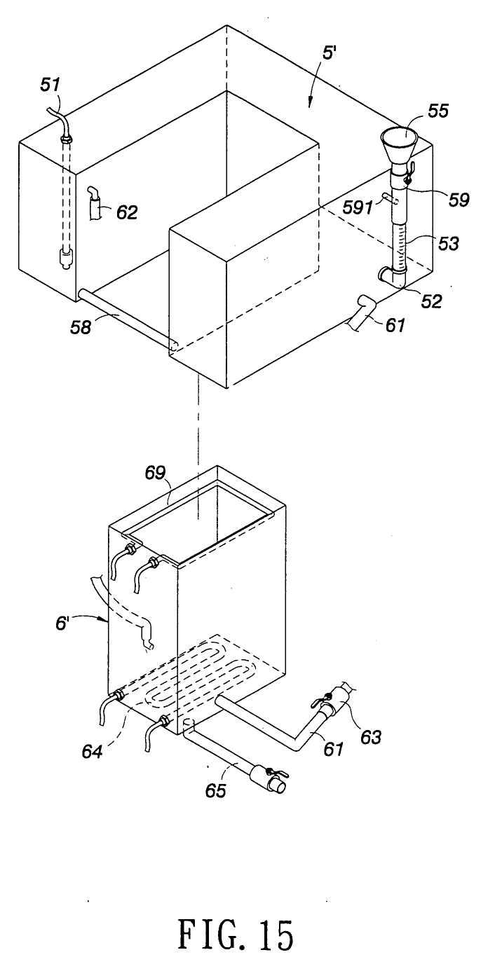

FIG. 13 shows another pictorial drawing of the apparatus. Compared to FIG. 1, the differences are an addition of the humidity selector (36) at the bottom position of the apparatus, and the shape changes of the tank (5′) and boiler (6′) as clearly shown on the FIG. 14 and FIG. 15. The tank (5′) from bird's-eye view shown as U-shaped contains larger volume than previous described one (5). A connecting pipe (58) links the front two ends of the U-shaped tank to become a recycling water tank. Between the transparent duct (53) and the funnel (55), a control valve (59) is equipped. A linking pipe (591) under the control valve (59) can connect to both tank (5′) and water intake pipe (52). After pouring water through funnel (55) into the tank (5′), air inside the tank can be rapidly forced out through the linking pipe (591) and water intake pipe so that water level will be raised rapidly and the tank (5′) will not become vacuum status. If water level higher than the linking pipe (591), then the tank (5′) will become vacuum status again, water will not be able to get into the tank (5′). Moreover, a dry-typed electric heat tube (69) will be equipped inside the top of the boiler (6′). The electric heat tube (69) can reheat and dehydrate the evaporated vapor and maintain relative saturated humidity with temperature of 70 to 80° C. This will help prevent flour-made steamed food like steamed dumplings and steamed stuffed bun from soggy (without its original gluten). Also, the vapor will not easily adhere to the inner glass walls of the apparatus. The humidity selector (36′) can adjust the temperature of the dry-typed electric heat tube (69) either manually or automatically on the front panel of the base (3′). As to the other configuration and functional parts, they are the same as former apparatus as described before, further description will not be provided.

The advantages of the implementation of this invention are as follows:
1. It saves time and conserves energy since water level inside the boiler always maintain lower volume so that water can be boiled rapidly after heating.
2. It saves human labor for adding water into the apparatus since water will be supplied from the tank automatically when there is no enough water in the boiler; and water supply will be stopped automatically when it reaches appropriate level in the boiler.
3. There is no need to worry if the steaming racks slide out when the racks are pulled out for food.
4. The circuit breaker can prevent the overloads of the electric current when there is no water supply.
5. The food in the apparatus can be seen clearly by projected light from the light base and further the light makes great advertising effect from the lampshade.
6. The water guiding slot equipped on the top edge of front panel of the steaming racks and the water guiding glass plates inside the apparatus body can all prevent water from dripping out and damping the desk top or floor.

1. A desk-top steaming apparatus comprising a body and a base, the base has a water tank and a water boiler, the body has a plurality of steaming racks, and each rack is supported by slide tracks on both sides, characterized in that:
a water tank having a water intake pipe, and the tank and the boiler are connected by a water intake pipe and an exhaust pipe, the position of the exhaust pipe is higher than that of the water intake pipe, one end of the exhaust pipe links to the higher position of the tank and the other one links to the lower position of the tank and boiler, respectively, but the position of the exhaust vent in the boiler has to be higher than that of the water intake vent, the distance between these two vents does not need to be long, the water level inside the boiler needs to be of the same height as that of the exhaust vent, water volume in the boiler will not be too much, so it helps produce high heat vapor during short period of time.

2. The apparatus of claim 1, wherein a drain pipe is equipped at the bottom level of the boiler, a drain valve can be added onto the drain pipe.

3. The apparatus of claim 1, wherein the water intake pipe between the tank and boiler can be equipped with a water intake valve.

4. The apparatus of claim 1, wherein a circuit breaker can be equipped inside the tank in order to prevent the overload of electric current when there is no water supply.

5. The apparatus of claim 1, wherein it is better to have position of the tank higher than that of the boiler in order to facilitate automatic water supply.

6. The apparatus of claim 1, wherein a light base and an advertising lamp shade can be added onto the top of the body; a lamp pipe is included in this light base, and several vent holes are designed on the top of the lamp shade, it also helps reach advertising effects when light is projected from the lamp pipe.

7. The apparatus of claim 6, wherein several holes are designed on the top of the light base and they are all covered by transparent lens in order to project light into the body.

8. The apparatus of claim 1, wherein a vent hole is created on the top of the boiler to disperse the vapor.

9. The apparatus of claim 1, wherein a central vent is designed on the top of the boiler, and several poles around the vent support the knob on the top of the central vent.

10. The apparatus of claim 1, wherein the steaming racks are presented as L-shaped and stacked, each rack is supported by slide tracks, the rack hooks are equipped on the bottom two sides of the rack, and buffers are located on the bottom two sides of the slide tracks, the buffers can stop the rack hooks and prevent the racks sliding out when pulled.

11. The apparatus of claim 10, wherein the water guiding slot is designed on the top edge of the front panel of the rack for the purpose of guiding water.

12. The apparatus of claim 1, wherein a tilted water guiding glass plate is equipped on the upper two sides of the body.

13. The apparatus of claim 1, wherein the water tank can be U-shaped as we can see from bird's-eye view, and the boiler is located inside the opening of the U shape.

14. The apparatus of claim 13, wherein a connecting pipe van be equipped between two ends of the U-shaped tank to make a recycling water tank.

15. The apparatus of claim 1, wherein a dry-typed electric heat tube can be equipped on the top inner side of the boiler, the tube will help reheat and dehydrate the evaporated vapor in order to control the humidity of the apparatus.

16. The apparatus of claim 13, wherein a dry-typed electric heat tube can be equipped on the top inner side of the boiler, the tube will help reheat and dehydrate the evaporated vapor in order to control the humidity of the apparatus.
